(19) United States
(12) Patent Application Publication
(10) Pub. No.: US 2025/0058482 A1
(43) Pub. Date: Feb. 20, 2025

(54) JOINT APPARATUS FOR ROBOT

(71) Applicants: NAVER CORPORATION, Seongnam-si (KR); Korea University of Technology and Education Industry-University Cooperation Foundation, Cheonan-si (KR)

(72) Inventors: Yong Jae KIM, Cheonan-si (KR); Seong Ho YUN, Goyang-si (KR); Jae Hyun PARK, Icheon-si (KR)

(73) Assignees: NAVER CORPORATION, Seongnam-si (KR); Korea University of Technology and Education Industry-University Cooperation Foundation, Cheonan-si (KR)

(21) Appl. No.: 18/934,968

(22) Filed: Nov. 1, 2024

Related U.S. Application Data
(63) Continuation of application No. PCT/KR2023/002640, filed on Feb. 24, 2023.

(30) Foreign Application Priority Data
May 4, 2022 (KR) 10-2022-0055216

(51) Int. Cl. B25J 17/02; B25J 9/10

(52) U.S. Cl. CPC B25J 17/0283; B25J 9/104; B25J 9/109

(57) ABSTRACT

A robot joint device may include a first frame unit having a first hollow portion, a second frame unit having a second hollow portion, the second frame unit spaced apart from the first frame unit, a rotational axis unit on and between the first and second hollow portions and configured to rotate around first, second and third axes which are perpendicular to one another, a first link unit extending to bypass the rotational axis unit, connected to each of the first and second frame units with the rotational axis unit interposed therebetween, and configured to rotate around the first and second axes, and a second link unit extending to bypass the rotational axis unit while intersecting with the first link unit, connected to each of the first and second frame units with the rotational axis unit interposed therebetween, and configured to rotate around the first and second axes.

### CROSS-REFERENCE TO RELATED APPLICATIONS

This U.S. non-provisional application is a continuation of and claims the benefit of priority under 35 U.S.C. § 365 (c) to International Application PCT/KR2023/002640, which has an International filing date of Feb. 24, 2023 and claims priority to Korean Patent Application No. 10-2022-0055216, filed May 4, 2022, the entire contents of each of which are incorporated herein by reference in their entirety.

### BACKGROUND

### 1. Field

The present disclosure relates to wrist joint devices for a robot capable of implementing multi-degree of freedom (DOF) movement.

### 2. Description of the Related Art

The conventional multi-degree of freedom (DOF) robot joint device is configured by connecting a plurality of single-DOF joints including motors and reducers. Accordingly, an increased mass of a distal end part decreases a payload (maximum weight that the robot may carry) and increases the possibility of collision when interacting with people, which may lead to dangerous problems.

To solve this problem, methods of positioning a heavy motor and a portion of a reducer at a base part, positioning a light 3-DOF joint structure at a distal end part, and/or driving the 3-DOF joint structure using a cable have been proposed.

The methods may increase the payload and improving the safety when interacting with people by positioning the heavy motor at the base part to reduce the mass of the distal end part. In addition, the methods may overcome the disadvantages of the existing cable-driven mechanism by realizing a wide operating angle and low frictional resistance.

However, these methods have problems such as a complicated joint structure, low rigidity and durability due to torsion, and/or difficulty in assembly. Therefore, to solve these problems, a new joint device is desired.

### SUMMARY

Some example embodiments of the present inventive concepts provide robot joint devices capable of implementing an operation of a wider range of motion of 3-degree of freedom (DOF) and having a simpler joint structure.

Some example embodiments of the present inventive concepts provide robot joint devices capable of more accurately measuring a rotation angle of a joint.

Some example embodiments of the present inventive concepts provide robot joint devices having higher torsional rigidity and allowing easier wiring.

Some example embodiments of the present inventive concepts provide robot joint devices capable of solving problems such as sudden bending of a cable, damage caused by the bending, and/or errors that have occurred in the existing driving method using a cable.

Some example embodiments of the present inventive concepts provide robot joint devices capable of implementing a yaw rotation using a cable.

According to an example embodiment of the present inventive concepts, a robot joint device includes a first frame unit having a first hollow portion, a second frame unit spaced apart from the first frame unit and having a second hollow portion, a rotational axis unit installed on and between the first hollow portion and the second hollow portion and configured to be rotatable around a first axis, a second axis, and a third axis, the first, second and third axes being perpendicular to one another, a first link unit extending to bypass the rotational axis unit, connected to each of the first and second frame units with the rotational axis unit interposed therebetween, and configured to be rotatable around the first and second axes, and a second link unit extending to bypass the rotational axis unit while intersecting with the first link unit, connected to each of the first and second frame units with the rotational axis unit interposed therebetween, and configured to be rotatable around the first and second axes, wherein each of the first and second link units has a cam slider portion configured to correct a connection length with the first and second frame units when rotating for a rolling motion, so that the second frame unit performs the rolling motion on a virtual sphere with respect to the first frame unit.

One end part of the first link unit connected to the first frame unit and one end part of the second link unit connected to the first frame unit may be perpendicular to each other with respect to the rotational axis unit, and the other end part of the first link unit connected to the second frame unit and the other end part of the second link unit connected to the second frame unit may be perpendicular to each other with respect to the rotational axis unit.

The cam slider portion may be at at least one of both end parts of the first link unit and both end parts of the second link unit, respectively.

The first link unit may include a first cam installed on the first and second frame units and configured to be rotatable around the first axis, and a first link installed on the first cam and configured to be rotatable around the second axis and configured to be relatively movable with respect to the first cam by slide movement, and the second link unit may include a second cam installed on the first and second frame units and configured to be rotatable around the second axis, and a second link installed on the second cam and configured to be rotatable around the first axis and configured to be relatively movable with respect to the second cam by the slide movement.

Each of the first and second cams may include a pinhole and a cam slot defined therein, each of the first and second links may include a hole and a slot defined therein, a link slider mounted in the pinhole and configured to be movable along the slot, and a cam slider mounted in the hole and configured to be movable along the cam slot.

According to an example embodiment of the present inventive concepts, the robot joint device may further include a sensing unit installed on the first frame unit and the first and second cams and configured to sense rotation angles of the first and second link units with respect to the first and second axes.

According to an example embodiment of the present inventive concepts, the robot joint device may further include another sensing unit configured to sense the rotation of the rotational axis unit with respect to the third axis.

According to an example embodiment of the present inventive concepts, the rotational axis unit may include a shaft having a hollow structure, a first joint having a hollow portion and being installed at both end parts of the shaft to be rotatable around the first axis, and a second joint having a hollow portion, connected to the first joint to be rotatable around the second axis, and installed at the first and second hollow portions to be rotatable around the third axis.

According to an example embodiment of the present inventive concepts, the robot joint device may further include a driving unit configured to rotate the second frame unit around the first and second axes with respect to the first frame unit.

The driving unit may include a first cable unit wound around a first pulley so that both sides of the first cable unit pass through the first frame unit and both end parts of the first cable unit are rotatably installed on the second frame unit, and a second cable unit wound around a second pulley so that both sides of the second cable unit pass through the first frame unit and both end parts of the second cable unit are rotatably installed on the second frame unit, and between the first frame unit and the second frame unit, both sides of the first cable unit may be positioned on a first plane, and both sides of the second cable unit may be positioned on a second plane perpendicular to the first plane.

According to an example embodiment of the present inventive concepts, the robot joint device may further include a cable guide installed in a hole of the first frame unit and having an opening through which the first or second cable unit passes, wherein an inner side surface of the opening may be provided with a rounded portion protruding inwardly, and the rounded portion is configured to guide bending of the first and second cable units when the second frame unit rotates with respect to the first frame unit.

The rounded portion may include: an inner round adjacent to the rotational axis unit, and an outer round extending upwardly than the inner round.

A point of the rounded portion protruding maximally inwardly of the opening may be spaced apart from the second frame unit in a direction farther away from the second frame unit than first and second rotational axes of the rotational axis unit corresponding to the first and second axes.

According to an example embodiment of the present inventive concepts, the robot joint device may further include a power transmission unit configured to transmit power to the rotational axis unit, wherein the power transmission unit may include a first bevel pulley, a second bevel pulley being perpendicular to the first bevel pulley, a cable wound around the first bevel pulley and the second bevel pulley to rotate the second bevel pulley by winding, and a power transmission shaft coupled to the second bevel pulley and configured to transmit rotational force to the rotational axis unit.

According to an example embodiment of the present inventive concepts, a robot joint device includes a first frame unit having a first hollow portion, a second frame unit spaced apart from the first frame unit and having a second hollow portion, a rotational axis unit installed on and between the first hollow portion and the second hollow portion and configured to be rotatable around a first axis, a second axis, and a third axis, the first, second and third axes being perpendicular to one another, a first link unit extending to bypass the rotational axis unit, connected to each of the first and second frame units with the rotational axis unit interposed therebetween, and configured to be rotatable around the first and second axes, a second link unit extending to bypass the rotational axis unit while intersecting with the first link unit, connected to each of the first and second frame units with the rotational axis unit interposed therebetween, and configured to be rotatable around the first and second axes, a first cable unit wound around a first pulley so that both sides of the first cable unit pass through the first frame unit and both end parts of the first cable unit are rotatably installed on the second frame unit, and a second cable unit wound around a second pulley so that both sides of the second cable unit pass through the first frame unit and both end parts of the second cable unit are rotatably installed on the second frame unit, wherein between the first frame unit and the second frame unit, both sides of the first cable unit are on a first plane, and both sides of the second cable unit are on a second plane perpendicular to the first plane.

According to an example embodiment of the present inventive concepts, the robot joint device may further include a cable guide installed in a hole of the first frame unit and having an opening through which the first or second cable unit passes, wherein an inner side surface of the opening may be provided with a rounded portion protruding inwardly to guide bending of the first and second cable units when the second frame unit rotates with respect to the first frame unit.

Some advantages of the present inventive concepts obtained through the above-described example embodiments are as follows.

First, because a rotational axis unit is connected to first and second frame units to be rotatable in three axes, the first and second frame units are connected so as to be rotatable in two axes, and a cam slider portion configured to correct the connection length with the first and second frame units is provided in each of first and second link units, a robot joint device having a simpler joint structure capable of implementing an operation of a wide range of motion of 3-degree of freedom (DOF) so that the second frame unit performs a rolling motion on a virtual sphere with respect to the first frame unit can be provided.

Second, because a sensing unit is configured to sense rotation angles of the first and second link units with respect to first and second axes and a rotation of the rotational axis unit with respect to a third axis, it is possible to accurately measure a rotation angle of the joint. When the joint device of an example embodiment of the present inventive concepts is provided at a wrist joint portion of the robot, the sensing technology can be applied to control the driving of the wrist more precisely.

Third, because a shaft of the rotational axis unit has a hollow shape with a larger outer diameter than before, it is possible to secure the higher torsional rigidity of the joint device. In addition, because an electric cable is disposed to pass through an inside of the shaft and first to third joints, it is possible to reduce or prevent the problems such as twisting and/or tension of the electric cable that may be caused by the operation of the joint in a structure where the electric cable is disposed externally.

Fourth, because the first frame unit is provided with a cable guide, it is possible to smoothly guide the bending of the cable, and the cable guide has a design that is divided into an inner round and an outer round in consideration of a difference in a contact range of the cable, it is possible to reduce or minimize the cable error due to the bending.

Fifth, by disposing a first bevel pulley and a second bevel pulley to be perpendicular to each other and connecting the first bevel pulley and the second bevel pulley using the cable to transmit rotational force to the rotational axis unit connected to the second bevel pulley, it is possible to implement a yaw rotation of the joint device.

### BRIEF DESCRIPTION OF THE DRAWINGS

FIG. 1 is a conceptual diagram of a robot joint device according to an example embodiment of the present inventive concepts.

FIG. 2 is a diagram illustrating part A of FIG. 1, and is a conceptual diagram in which a frame cover of the second frame unit is removed.

FIG. 3 is an exploded view illustrating main components forming part A of FIG. 1.

FIG. 4 is a conceptual diagram for describing a 1-degree of freedom (DOF) rolling joint using a variable link.

FIG. 5 is a conceptual diagram for describing a 2-DOF rolling joint using two variable links disposed perpendicular to each other with respect to a center link.

FIG. 6 is a conceptual diagram for describing 1-DOF rolling joint control using a cable.

FIG. 7 is a conceptual diagram for describing 2-DOF rolling joint control using a cable.

FIG. 8 is an exploded perspective view of a cam slider portion illustrated in FIG. 3.

FIG. 9 is a conceptual diagram illustrating a structural change of the cam slider portion according to a roll rotation of a second frame unit illustrated in FIG. 2.

FIG. 10 is a conceptual diagram illustrating the structural change of part A when a hand illustrated in FIG. 1 is yaw rotated.

FIG. 11 is a conceptual diagram illustrating the structural change of part A when the second frame unit illustrated in FIG. 2 performs a rolling motion (roll and/or pitch rotation) on a virtual sphere.

FIG. 12 is a cross-sectional diagram of part A of FIG. 1.

FIG. 13 is a conceptual diagram illustrating a state in which the second frame unit performs the rolling motion (roll and pitch rotation) on the virtual sphere in the state illustrated in FIG. 12.

FIG. 14 is a cross-sectional diagram of the robot joint device illustrated in FIG. 1.

### DETAILED DESCRIPTION

Hereinafter, some example embodiments disclosed in this specification will be described in detail with reference to the accompanying drawings, but the same or similar components will be denoted by the same reference numerals independent of the drawing numerals, and an overlapping description of the same or similar components will be omitted. In addition, the terms “module” and “unit” for components used in the following description are used only to easily make the disclosure. Therefore, these terms do not have meanings or roles that distinguish from each other in themselves. Further, in describing the example embodiments disclosed in this specification, if it is determined that a detailed description of related known technologies may obscure the gist or features of the example embodiments disclosed in this specification, the detailed description thereof is omitted. In addition, it is to be understood that the accompanying drawings are provided only for easy understanding of the example embodiments disclosed in this specification, and the technical ideas disclosed in this specification is not limited by the accompanying drawings, but includes all the modifications, equivalents, and substitutions included in the spirit and the scope of the present inventive concepts.

The terms including ordinal numbers such as ‘first’ and ‘second’ may be used to describe various components, but these components are not limited by these terms. The terms are used to distinguish one component from another component.

It is to be understood that when one component is referred to as being “connected to” or “coupled to” another component, one component may be connected directly to or coupled directly to another component or be connected to or coupled to another component with the other component interposed therebetween. On the other hand, it is to be understood that when one component is referred to as being “connected directly to” or “coupled directly to” another component, it may be connected to or coupled to another component without the other component interposed therebetween.

Singular forms include plural forms unless the context clearly indicates otherwise.

It will be further understood that the terms “include” or “have” used in the present specification specify the presence of features, numerals, steps, operations, components, parts mentioned in the present specification, or combinations thereof, but do not preclude the presence or addition of one or more other features, numerals, steps, operations, components, parts, or combinations thereof.

As used herein, expressions such as “at least one of,” when preceding a list of elements, modify the entire list of elements and do not modify the individual elements of the list. Thus, for example, both “at least one of A, B, or C” and “at least one of A, B, and C” mean either A, B, C or any combination thereof. Likewise, A and/or B means A, B, or A and B.

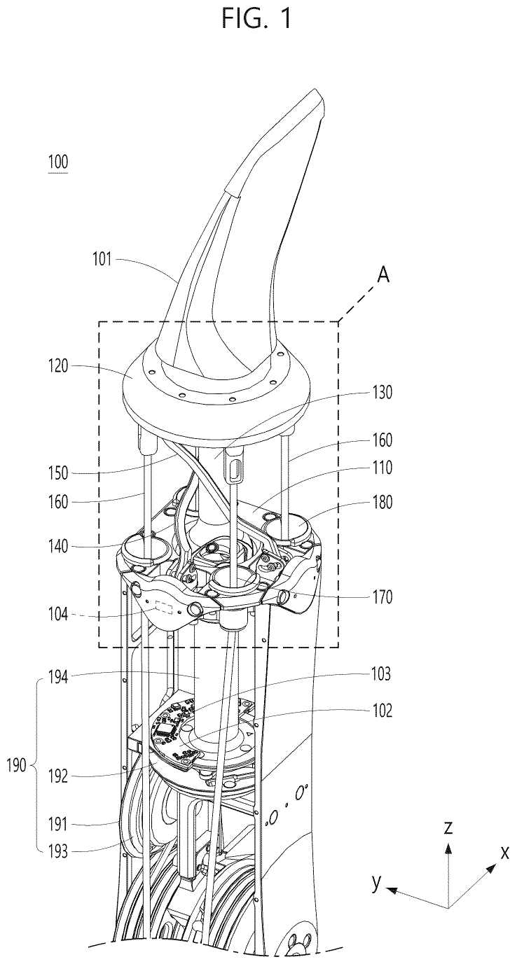

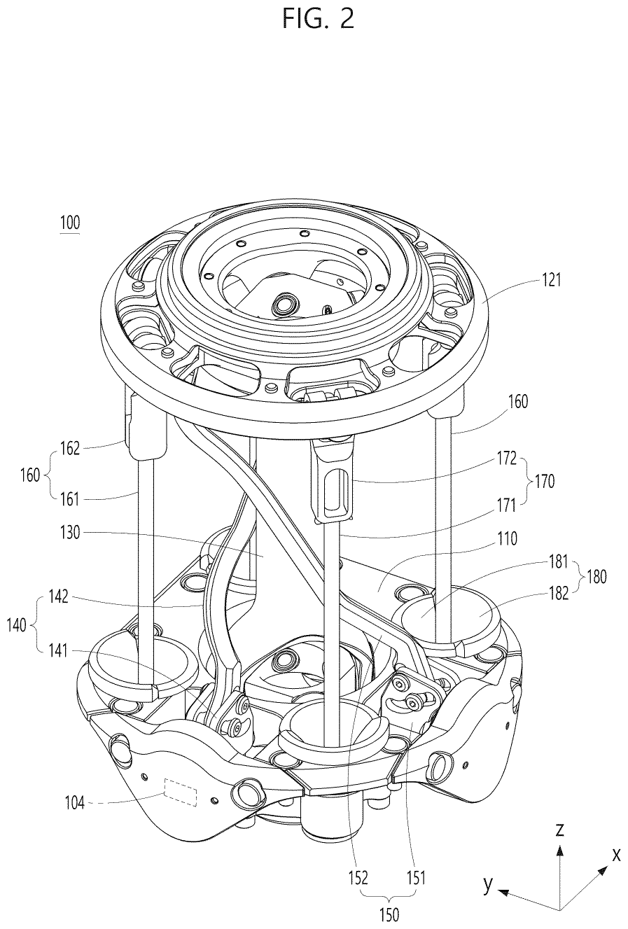

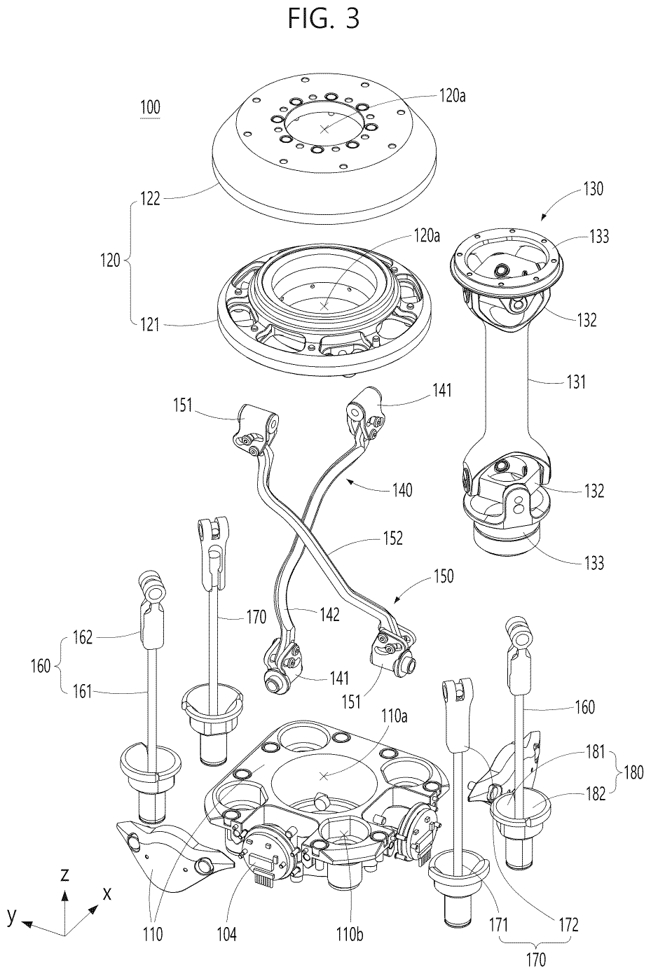

FIG. 1 is a conceptual diagram of a robot joint device 100 according to an example embodiment of the present inventive concepts, FIG. 2 is a diagram illustrating part A of FIG. 1, and is a conceptual diagram in which a frame cover 122 of the second frame unit 120 is removed, and FIG. 3 is an exploded view illustrating main components forming part A of FIG. 1.

Referring to FIGS. 1 to 3, a robot joint device 100 of the present inventive concepts may be applied to a wrist portion of a humanoid robot. The robot joint device 100 includes a first frame unit 110, a second frame unit 120, a rotational axis unit 130, a first link unit 140, a second link unit 150, and driving units 160 and 170.

The first frame unit 110 has a first hollow portion 110a. The first hollow portion 110a may be provided at a center (or a central area) of the first frame unit 110. The first frame unit 110 may be connected to a forearm frame extending from an elbow portion toward a wrist portion.

The second frame unit 120 is disposed to be spaced apart from the first frame unit 110 and may have a second hollow portion 120a. The second hollow portion 120a may be provided at a center (or a central area) of the second frame unit 120. In a reference state where the second frame unit 120 is disposed parallel to the first frame unit 110, the second hollow portion 120a is positioned to overlap the first hollow portion 110a along a spaced direction (e.g., along Z-axis direction in the drawing).

The rotational axis unit 130 is installed on and between the first hollow portion 110a and the second hollow portion 120a, to be rotatable around a first axis (X-axis in the drawing), a second axis (Y-axis in the drawing), and a third axis (Z-axis in the drawing) that are perpendicular to each other. The second frame unit 120 may be provided with a hand 101, and the hand 101 may rotate around the third axis when the rotational axis unit 130 rotates around the third axis.

In the present example embodiment, the second frame unit 120 is configured to include a base frame 121 and a frame cover 122 configured to be rotatable around the third axis with respect to the base frame 121. The frame cover 122 may rotate around the third axis when the rotational axis unit 130 rotates around the third axis, and the hand 101 is mounted on the frame cover 122.

By the rotational axis unit 130, the second frame unit 120 is configured to be rotatable (roll and/or pitch rotation) around at least one of the first and second axes with respect to the first frame unit 110, and the frame cover 122 and the hand 101 mounted on the frame cover 122 are configured to be rotatable (yaw rotation) around the third axis with respect to the base frame 121. That is, the robot joint device 100 of the present inventive concepts has 3-degree of freedom (DOF) that enables a rotation (formally bending) in a roll direction and a pitch direction and a yaw rotation of a distal end part (hand 101).

In the present example embodiment, the rotational axis unit 130 is configured to include a shaft 131, a first joint 132, and a second joint 133.

The shaft 131 may have a hollow structure. As will be described below, the empty space inside shaft 131 can be utilized as a structure for wiring. Conventionally, the shaft 131, which has a smaller outer diameter and a structure in which the inside of the shaft 131 is filled, was used. However, the shaft 131 of the present inventive concepts has a larger outer diameter than the existing outer diameter and has a hollow structure. Thus, a higher torsional rigidity of the joint device 100 may be secured.

The first joint 132 is connected to both end part of the shaft 131 to be rotatable around the first axis. To this end, the both end parts of the shaft 131 may have a shape branched in a ‘Y’ shape. The first joint 132 has a hollow portion inside for wiring.

The second joint 133 is connected to the first joint 132 to be rotatable around the second axis, and is installed to each of the first and second hollow portions 110a and 120a to be rotatable around the third axis. The second joint 133 has a hollow portion inside for wiring.

For reference, in this drawing, the rotation of the second frame unit 120 around a fourth axis inclined at 45° to the first axis with respect to the first frame unit 110 is illustrated as roll, the rotation of the second frame unit 120 around a fifth axis inclined at 45° to the second axis is illustrated as pitch, and the rotation of the second frame unit 120 around the third axis is illustrated as a yaw.

When the second frame unit 120 rotates with respect to the first frame unit 110, the rotation is performed as a rolling motion on a virtual sphere. In this case, the virtual sphere is formed by a virtual hemisphere having a radius of ½ of a length of the rotational axis unit 130 in each of the first and second frame units 110 and 120. The rolling motion will be described in detail below.

The first link unit 140 extends to bypass the rotational axis unit 130 and is connected to each of the first and second frame units 110 and 120 with the rotational axis unit 130 interposed therebetween. The first link unit 140 is installed on each of the first and second frame units 110 and 120 to be rotatable around the first and second axes. Both end parts of the first link unit 140, which are connected to each of the first and second frame units 110 and 120, are disposed on a virtual first plane crossing the rotational axis unit 130.

The second link unit 150 extends to bypass the rotational axis unit 130 while intersecting the first link unit 140, and is connected to each of the first and second frame units 110 and 120 with the rotational axis unit 130 interposed therebetween. The second link unit 150 is installed on each of the first and second frame units 110 and 120 to be rotatable around the first and second axes. Both end portions of the second link unit 150 connected to each of the first and second frame units 110 and 120 are disposed on a virtual second plane that is perpendicular to the virtual first plane while crossing the rotational axis unit 130.

One end part of the first link unit 140 connected to the first frame unit 110 and one end part of the second link unit 150 connected to the first frame unit 110 are disposed perpendicular to each other around the rotational axis unit 130. One end part of the first link unit 140 is installed on the first frame unit 110 to be rotatable around the first axis, and one end part of the second link unit 150 is installed on the first frame unit 110 to be rotatable around the second axis.

The other end part of the first link unit 140 connected to the second frame unit 120 and the other end part of the second link unit 150 connected to the second frame unit 120 are disposed perpendicular to each other around the rotational axis unit 130. The other end part of the second link unit 150 is installed on the second frame unit 120 to be rotatable around the first axis, and the other end part of the second link unit 150 is installed on the second frame unit 120 to be rotatable around the second axis.

For reference, in the present example embodiment, the structure using two link units (first and second link units 140 and 150), which is the minimum number for implementing a mechanism, is illustrated for the purpose of simplifying the structure, but the present inventive concepts are not limited thereto.

In addition to the first and second link units, one or two link units may be additionally provided. In this case, there is an advantage of improved strength and rigidity compared to the structure of the present example embodiment.

For example, when one link unit is additionally provided and the added link unit is named a third link unit, the third link unit may be disposed symmetrically to the first or second link unit 140 and 150 around the rotational axis unit 130.

For another example, when two link units are additionally provided and the added link units are named the third link unit and a fourth link unit, the third and fourth link units may be disposed symmetrically to the first and second link units 140 and 150 around the rotational axis unit 130.

The driving units 160 and 170 are formed to rotate the second frame unit 120 around the first and second axes with respect to the first frame unit 110. That is, by the driving units 160 and 170, the second frame unit 120 may perform a rolling motion on a virtual sphere with respect to the first frame unit 110, and may be roll and/or pitch rotated.

The driving units 160 and 170 include the first cable unit 160 and the second cable unit 170.

The first cable unit 160 is wound around a first pulley (not illustrated). The first pulley may be provided at the elbow portion or the forearm portion. Based on the first pulley, both sides of the first cable unit 160 each are rotatably connected to the second frame unit 120 by passing through the first frame unit 110. In the present example embodiment, it is illustrated that the first cable unit 160 is configured to include a first cable 161 and a first coupler 162 coupled to both end parts of the first cable 161, and the first coupler 162 is installed on the second frame unit 120 to be rotatable around the fourth and fifth axes. For reference, within the plane (XY plane) formed by the first and second axes, the fourth axis is disposed to be inclined at 45° with respect to the first axis, the fifth axis is disposed to be inclined at 45° with respect to the second axis, and the fourth and fifth axes are disposed perpendicular with respect to the third axis.

The second cable unit 170 is wound around a second pulley (not illustrated). The second pulley may be provided at the elbow portion or the forearm portion. Based on the second pulley, both sides of the second cable unit 170 each are rotatably connected to the second frame unit 120 by passing through the first frame unit 110. In the present example embodiment, it is illustrated that the second cable unit 170 is configured to include a second cable 171 and a second coupler 172 coupled to both end parts of the second cable 172, and the second coupler 172 is installed on the second frame unit 120 to be rotatable around the fourth and fifth axes.

However, the present inventive concepts are not limited thereto. The first and second couplers 162 and 172 may be formed in a ball shape and installed to be freely rotatable on a socket mount of the second frame unit 120.

Between the first frame unit and the second frame unit, both sides of the first cable unit are positioned on a first plane, and both sides of the second cable unit are positioned on a second plane perpendicular to the first plane.

Meanwhile, each of the first and second link units 140 and 150 is provided with a cam slider portion configured to correct the connection length with the first and second frame units 110 and 120 when the second frame unit 120 rotates while performing the rolling motion on the virtual sphere with respect to the first frame unit 110.

The cam slider portion may be provided at at least one of both end parts of the first link unit 140 and at least one of both end parts of the second link unit 150. In the present example embodiment, it is illustrated that the cam slider portions are provided at the both end parts of the first link unit 140 and the both end parts of the second link unit 150, respectively, so as to simulate the rolling motion through more precise correction of the connection length.

In this way, because the rotational axis unit 130 is connected to the first and second frame units 110 and 120 to be rotatable around three axes, the first and second frame units 110 and 120 are connected to be rotatable around two axes, and the cam slider portion is provided to correct the connection length with the first and second frame units 110 and 120, respectively, the robot joint device 100 with a simpler joint structure capable of implementing an operation of a wide range of motion with 3-DOF by allowing the second frame unit 120 to perform the rolling motion on the virtual sphere with respect to the first frame unit 110 may be provided.

Hereinafter, the rolling motion described above and the structure implementing the rolling motion will be described in more detail.

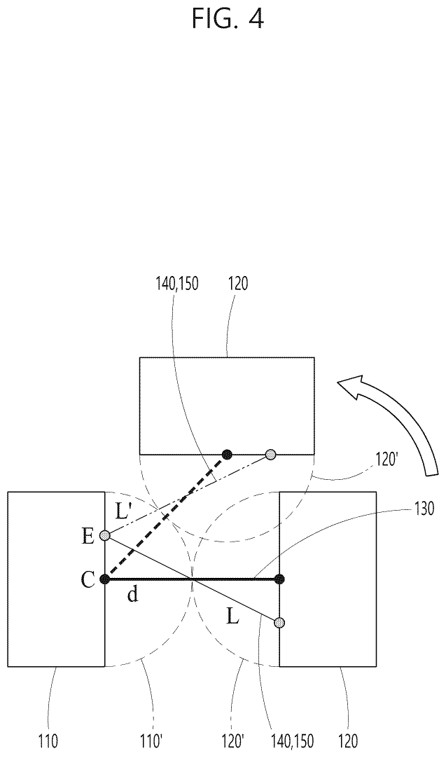

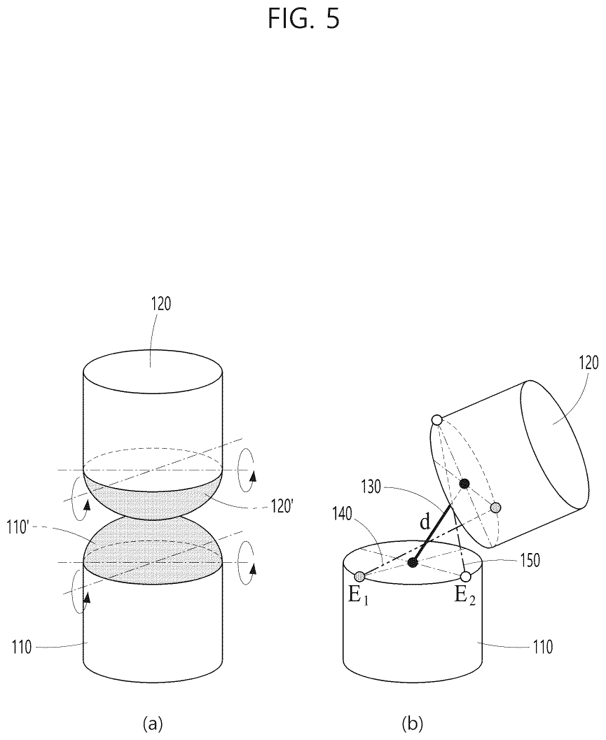

FIG. 4 is a conceptual diagram for describing a 1-DOF rolling joint using a variable link, and FIG. 5 is a conceptual diagram for describing a 2-DOF rolling joint using two variable links disposed perpendicular to each other with respect to a center link.

First, referring to FIG. 4, the rotational axis unit 130 is connected to a center C of one surface of the first frame unit 110 and a center C of one surface of the second frame unit 120. Here, it is assumed that virtual semicircles 110′ and 120′ having a radius of ½ of length d of the rotational axis unit 130 are formed on one surface of the first frame unit 110 and one surface of the second frame unit 120, respectively.

In this case, the virtual semicircle 120′ formed on the second frame unit 120 is formed to rotate without the rolling motion (e.g., slipping) while being in contact with the virtual semicircle 110′ formed on the first frame unit 110. In order to simulate the rolling motion, the link units 140 and 150 are connected to a position E eccentric from the center of one surface of the first frame unit 110 and a position E eccentric from the center of one surface of the second frame unit 120. In the state where the first frame unit 110 and the second frame unit 120 are disposed to face each other, both end parts of the first and second link units 140 and 150 connected to each of the first and second frame units 110 and 120 are positioned on one side and the other side (e.g., in a diagonal direction) based on the rotational axis unit 130.

In this case, in order for the link units 140 and 150 to accurately simulate the rolling motion, the link units 140 and 150 are configured to have variable lengths L and L′. That is, by the rotational axis unit 130 and the link units 140 and 150 corrected to have the desired or optimized lengths L and L′ according to the angle of the rolling motion, the second frame unit 120 may perform the rolling motion on the virtual semicircle 110′ and 120′ with respect to the first frame unit 110.

When the 1-DOF rolling joint structure extends to a 2-DOF rolling joint structure, it is as illustrated in FIG. 5. Referring to FIG. 5, the rotational axis unit 130 is connected to the center of one surface of the first frame unit 110 and the center of one surface of the second frame unit 120. Here, it is assumed that virtual hemispheres 110′ and 120′ having a radius of ½ of length d of the rotational axis unit 130 are formed on one surface of the first frame unit 110 and one surface of the second frame unit 120, respectively.

In this case, the virtual hemisphere 120′ formed on the second frame unit 120 is formed to rotate without the rolling motion (e.g., slipping) while being in contact with the virtual hemisphere 110′ formed on the first frame unit 110. In order to simulate the rolling motion, the first link unit 140 and the second link unit 150, which are connected to the first and second frame units 110 and 120 and disposed to intersect each other, are provided around the rotational axis unit 130.

One end part of the first link unit 140 connected to the first frame unit 110 and one end part of the second link unit 150 connected to the first frame unit 110 are disposed perpendicular to each other with respect to the rotational axis unit 130, and the other end part of the first link unit 140 connected to the second frame unit 120 and the other end part of the second link unit 150 connected to the second frame unit 120 are disposed perpendicular to each other with respect to the rotational axis unit 130.

In the state where the first frame unit 110 and the second frame unit 120 are disposed to face each other, a first pair of one end part of the first link unit 140 and one end part of the second link unit 150 connected to the first and second frame units 110 and 120, respectively, are positioned on one side and a second pair of another end part of the first link unit 140 and another end part of the second link unit 150 connected to the first and second frame units 110 and 120, respectively, are positioned on the other side based on the rotational axis unit 130. In other words, the first pair of end parts of the first and second link units 140 and 150 and the second pair of end parts of the first and second link units 140 and 150 are positioned in a diagonal direction based on the rotational axis unit 130.

Even in this case, in order for the first and second link units 140 and 150 to accurately simulate the rolling motion, the first and second link units 140 and 150 are configured to have variable lengths. That is, by the rotational axis unit 130 and the first and second link units 140 and 150 corrected to have the desired or optimized lengths according to the angle of the rolling motion, the second frame unit 120 may perform the rolling motion on the virtual hemisphere 110′ and 120′ with respect to the first frame unit 110.

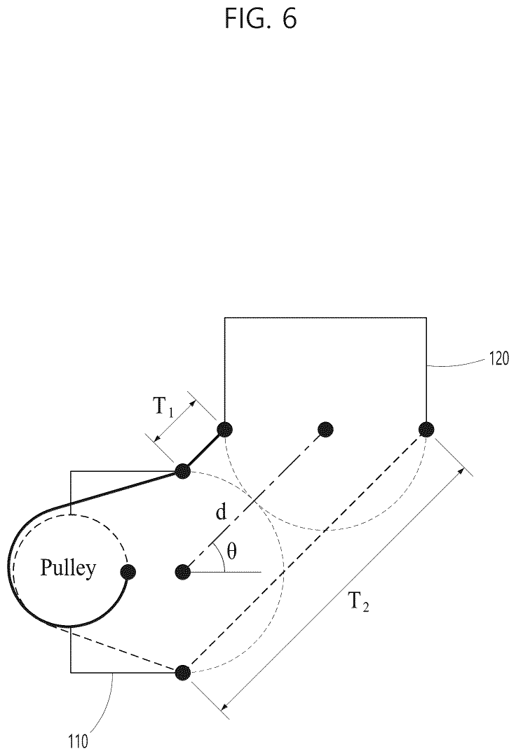

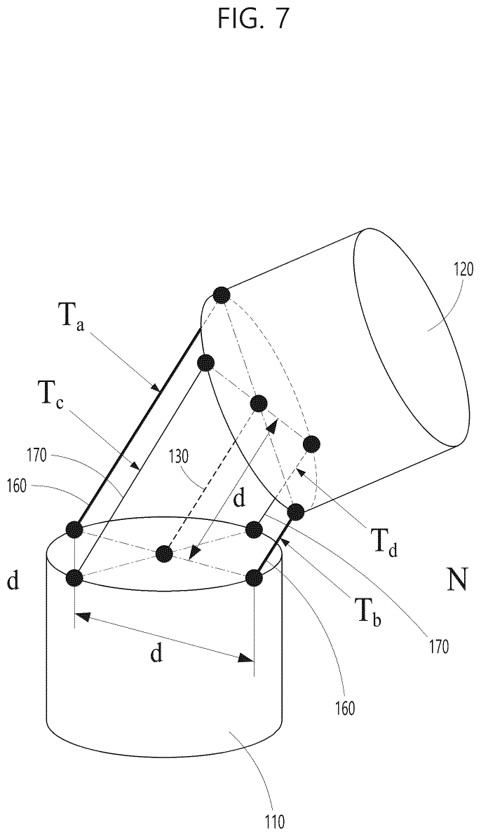

FIG. 6 is a conceptual diagram for describing 1-DOF rolling joint control using a cable, and FIG. 7 is a conceptual diagram for describing 2-DOF rolling joint control using a cable.

First, referring to FIG. 6, the motion of the 1-DOF rolling joint of FIG. 4 above may be controlled using a single cable.

For example, the cable is wound around a pulley, and when the pulley rotates in one direction, one side of the cable becomes shorter and the other side of the cable becomes longer. Conversely, when the pulley rotates in the other direction, one side of the cable becomes longer and the other side of the cable becomes shorter. In this case, the length of the cable shortened by being wound around the pulley is the same as the length of the cable lengthened by being unwound from the pulley.

Next, one side of the cable passes over one end of a semicircle having a radius of r=d/2 formed on the first frame unit 110 and is then fixed to one end of a semicircle having a radius of r=d/2 formed on the second frame unit 120. In this case, the length of the cable connecting one end of the semicircle formed on the first frame unit 110 and one end of the semicircle formed on the second frame unit 120 is defined as T1.

In addition, the other side of the cable passes over the other side of the semicircle having a radius of r=d/2 formed on the first frame unit 110 and is then fixed to the other end of the semicircle having a radius of r=d/2 formed on the second frame unit 120. In this case, the length of the cable connecting the other end of the semicircle formed on the first frame unit 110 and the other end of the semicircle formed on the second frame unit 120 is defined as T2.

According to the above-described configuration, when the pulley rotates in one direction, one side of the cable becomes shorter, so the rolling motion occurs so that one end of the semicircle formed on the first frame unit 110 and one end of the semicircle formed on the second frame unit 120 come closer to each other. That is, T1 becomes shorter. In this case, the other end of the semicircle formed on the first frame unit 110 and the other end of the semicircle formed on the second frame unit 120 move away from each other, and the other side of the cable becomes longer correspondingly. That is, T2 becomes longer.

Conversely, when the pulley rotates in the other direction, the other side of the cable becomes shorter, so the rolling motion occurs so that the other end of the semicircle formed on the first frame unit 110 and the other end of the semicircle formed on the second frame unit 120 come closer to each other. That is, T2 becomes shorter. In this case, the one end of the semicircle formed on the first frame unit 110 and the one end of the semicircle formed on the second frame unit 120 are far away from each other, and one side of the cable becomes shorter correspondingly. That is, T1 becomes longer.

In this way, in the state where two semicircles having the same radius of r (e.g., 2/d) are in rolling contact with each other and rotate 0°, the sum of lengths of T1 and T2 is constant as 2d as illustrated below.

$$\begin{matrix}d = 2 r , T 1 = 2 r - 2 r sin θ , T 2 = 2 r + 2 r sin θ \\ T 1 + T 2 = 2 d\end{matrix}$$

This indicates that the motion of the 1-DOF rolling joint of FIG. 4 above may be controlled using a single cable.

When the concept of controlling the 1-DOF rolling joint using the cable is applied by extending to the 2-DOF rolling joint structure, it is as illustrated in FIG. 7.

As illustrated in FIG. 7, the motion of the 2-DOF rolling joint may be controlled using two cables.

For example, the first cable unit 160 is wound around the first pulley (not illustrated) positioned at a lower side of the first frame unit 110 in the drawing, and thus when the first pulley rotates in one direction, one side of the first cable unit 160 becomes shorter and the other side of the first cable unit 160 becomes longer. Conversely, when the first pulley rotates in the other direction, one side of the first cable unit 160 becomes longer and the other side of the first cable unit 160 becomes shorter. In this case, the length of the cable shortened by being wound around the first pulley is the same as the length of the cable lengthened by being unwound from the first pulley.

Similarly, the second cable unit 170 is wound around the second pulley (not illustrated) positioned at the lower side of the first frame unit 110 in the drawing, and thus when the second pulley rotates in one direction, one side of the second cable unit 170 becomes shorter and the other side of the second cable unit 170 becomes longer. Conversely, when the second pulley rotates in the other direction, one side of the second cable unit 170 becomes longer and the other side of the second cable unit 170 becomes shorter. In this case, the length of the cable shortened by being wound around the second pulley is the same as the length of the cable lengthened by being unwound from the second pulley.

Next, one side of the first cable unit 160 passes over one end of the hemisphere (not illustrated in this drawing, see 110′ of FIG. 5) having a radius of r (e.g., d/2) formed on the first frame unit 110, and is then fixed to one end of the hemisphere (not illustrated in this drawing, see 120′ of FIG. 5) having a radius of r (d/2) formed on the second frame unit 120. In this case, the length of the first cable unit 160 connecting one end of the hemisphere 110′ formed on the first frame unit 110 and one end of the hemisphere 120′ formed on the second frame unit 120 is defined as Ta.

In addition, the other side of the first cable unit 160 passes over the other end of the hemisphere (not illustrated in this drawing, see 110′ of FIG. 5) having a radius of r (e.g., d/2) formed on the first frame unit 110, and is then fixed to the other end of the hemisphere (not illustrated in this drawing, see 120′ of FIG. 5) having a radius of r (d/2) formed on the second frame unit 120. In this case, the length of the first cable unit 160 connecting the other end of the hemisphere 110′ formed on the first frame unit 110 and the other end of the hemisphere 120′ formed on the second frame unit 120 is defined as Tb.

Ta and Tb are disposed on both sides based on the rotational axis unit 130.

Similarly, one side of the second cable unit 170 passes over one end of the hemisphere (not illustrated in this drawing, see 110′ of FIG. 5) having a radius of r (e.g., d/2) formed on the first frame unit 110, and is then fixed to one side of the hemisphere (not illustrated in this drawing, see 120′ of FIG. 5) having a radius of r (e.g., d/2) formed on the second frame unit 120. In this case, the length of the second cable unit 170 connecting one end of the hemisphere 110′ formed on the first frame unit 110 and one end of the hemisphere 120′ formed on the second frame unit 120 is defined as Tc.

In addition, the other side of the second cable unit 170 passes over the other end of the hemisphere (not illustrated in this drawing, see 110′ of FIG. 5) having a radius of r (e.g., d/2) formed on the first frame unit 110, and is then fixed to the other end of the hemisphere (not illustrated in this drawing, see 120′ of FIG. 5) having a radius of r (e.g., d/2) formed on the second frame unit 120. In this case, the length of the second cable unit 170 connecting the other end of the hemisphere 110′ formed on the first frame unit 110 and the other end of the hemisphere 120′ formed on the second frame unit 120 is defined as Td.

Tc and Td are disposed on both sides based on the rotational axis unit 130. Tc is positioned at a position rotated 90° with respect to Ta around the rotational axis, and Td is positioned at a position rotated 90° with respect to Tc around the rotational axis.

According to the above-described configuration, by controlling the rotation of the first and second pulleys, the lengths of Ta and Tb of the first cable unit 160 and Tc and Td of the second cable unit 170 may be adjusted, so the second frame unit 120 may implement the rolling motion with respect to the first frame unit 110.

According to the same principle as described above, the sum of the lengths of Ta and Tb and the sum of the lengths of Tc and Td are each constant as 2d during the rolling motion.

$$T a + T b = T c + T d = 2 d$$

This indicates that the motion of the 2-DOF rolling joint of FIG. 5 above may be controlled using two cables.

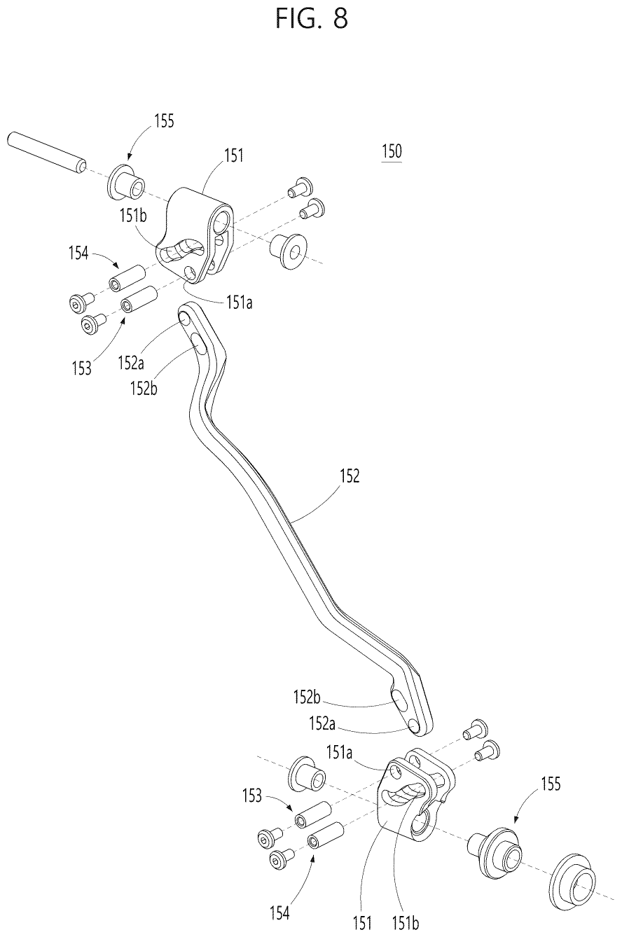

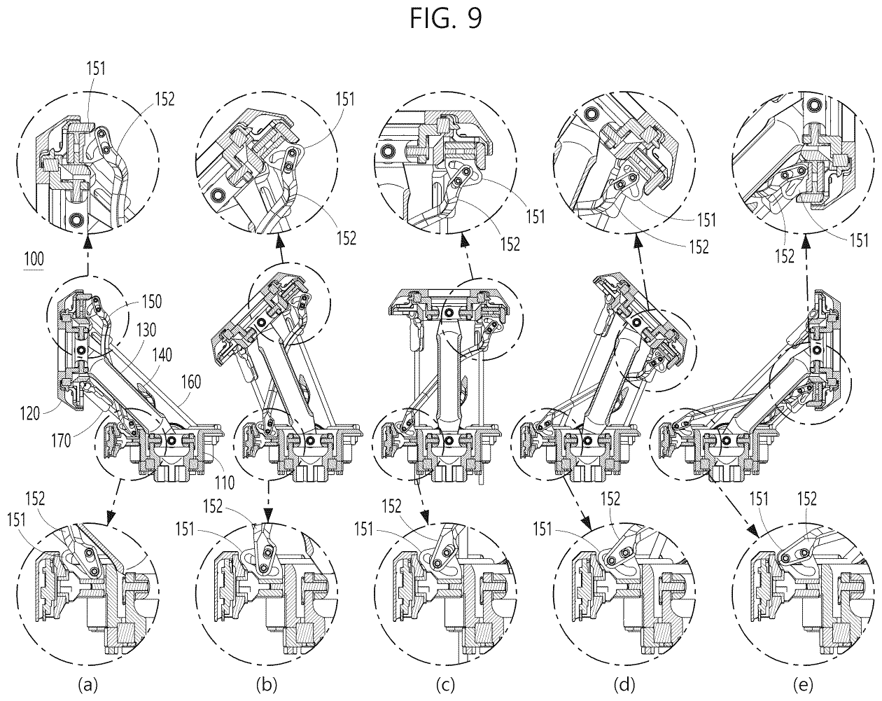

FIG. 8 is an exploded perspective view of the cam slider portion illustrated in FIG. 3, and FIG. 9 is a conceptual diagram illustrating the structural change of the cam slider portion according to the roll rotation of the second frame unit 120 illustrated in FIG. 2.

Referring to FIG. 8 together with FIG. 3 above, the first link unit 140 includes a first link 142 and first cams 141 connected to both sides of the first link 142, respectively. The first cams 141 are installed on the first and second frame units 110 and 120, respectively, to be rotatable around the first axis. The first link 142 is installed on the first cam 141 to be rotatable around the second axis and is configured to be able to relatively move with respective to the first cam 141 by slide movement.

Similarly, the second link unit 150 includes a second link 152 and second cams 151 connected to both sides of the second link 152, respectively. The second cams 151 are installed on the first and second frame units 110 and 120, respectively, to be rotatable around the second axis. The second link 152 is installed on the second cam 151 to be rotatable around the first axis and is configured to be able to relatively move with respective to the second cam 151 by the slide movement.

The first link 142 and the first cam 141, and the second link 152 and the second cam 151 are provided with the cam slider portion described above. When the second frame unit 120 rotates with respective to the first frame unit 110, the cam slider portion is configured to correct the connection length with the first and second frame units 110 and 120.

For example, the cam slider portion includes a pinhole 151a and a cam slot 151b formed on the first and second cams 141 and 151, a hole 152a and a slot 152b formed on the first and second links 142 and 152, a link slider 153 mounted in the pinhole 151a and formed to be movable along the slot 152b, and a cam slider 154 mounted in the hole 152a and formed to be movable along the cam slot 151b.

Here, the pinhole 151a and the hole 151b fix the link slider 153 and the cam slider 154, respectively, and the cam slot 151b and the slot 152 guide the movement of the cam slider 154 and the link slider 153, respectively.

The cam slot 151b and the slot 152b are formed to extend in a preset or desired shape. In the present example embodiment, it is illustrated that the cam slot 151b is formed in a free curve shape, and the slot 152b is formed in a straight line shape. However, the present inventive concepts are not limited thereto. The cam slot 151b and the slot 152b may be modified into various shapes as long as the second frame unit 120 may simulate the rolling motion with respect to the first frame unit 110.

By the above-described structure, as illustrated in FIG. 9, when the second frame unit 120 performs the rolling motion with respect to the first frame unit 110, the relative position of the first link 142 with respect to the first cam 141 and the relative position of the second link 152 with respect to the second cam 151 may be adjusted.

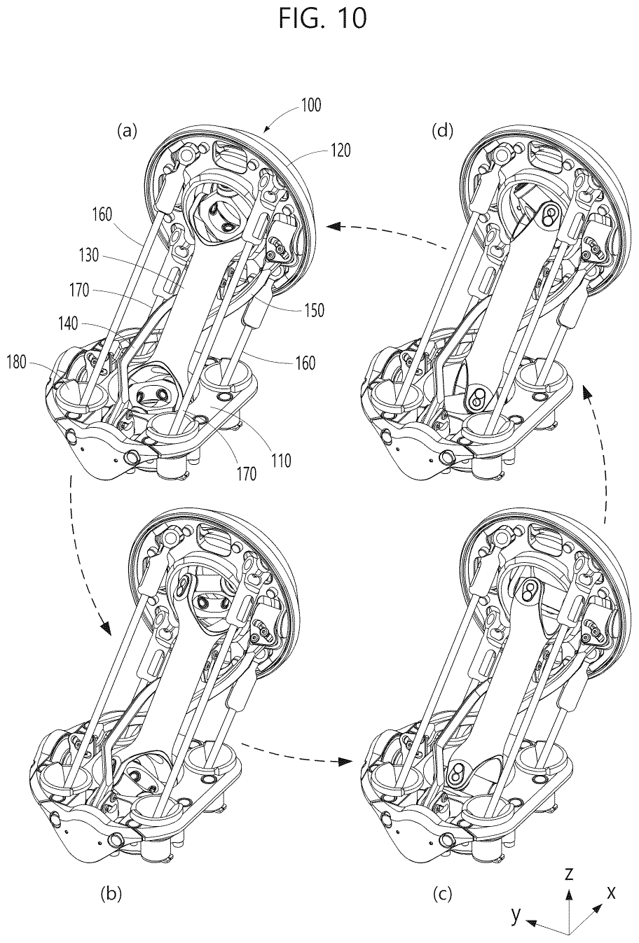

FIG. 10 is a conceptual diagram illustrating the structural change of part A when the hand 101 illustrated in FIG. 1 is yaw rotated.

Referring to FIG. 10 together with FIG. 1 above, the rotational axis unit 130 is installed on each of the first hollow portion 110a and the second hollow portion 120a to be rotatable around a central axis (corresponding to the third axis in FIG. 1) of each hollow portion. Accordingly, the rotational axis unit 130 can be rotated in place (e.g., yaw rotated) while the positions of the first frame unit 110 and the second frame unit 120 are fixed. By the yaw rotation, the frame cover 122 of the second frame unit 120 and the hand 101 mounted on the frame cover 122 are also yaw rotated together.

In this case, because the positions of the first frame unit 110 and the second frame unit 120 are fixed, the first and second cable units 160 and 170, and the first and second link units 140 and 150 remain fixed without changing in length.

A power transmission unit 190 is provided to transmit power to the rotational axis unit 130 using the cable so that the rotational axis unit 130 may be rotated in place (e.g., yaw rotated). The power transmission unit 190 includes a first bevel pulley 191, a second bevel pulley 192, a cable 193, and a power transmission shaft 194.

The first bevel pulley 191 is disposed so that a rotational axis of the first bevel pulley 191 is placed perpendicular to an extension direction of the power transmission shaft 194. In this drawing, it is illustrated that the first bevel pulley 191 is disposed parallel to an inner side of the forearm frame.

The second bevel pulley 192 is disposed so that a rotational axis of the second bevel pulley 192 is placed perpendicular to the rotational axis of the first bevel pulley 191.

The cable 193 is wound around the first bevel pulley 191 and the second bevel pulley 192 to link between the first bevel pulley 191 and the second bevel pulley 192. That is, when the first bevel pulley 191 rotates in one direction, the cable 193 is wound in one direction, causing the second bevel pulley 192 to rotate clockwise, and when the first bevel pulley 191 rotates in the other direction, the cable 193 is wound in the other direction, causing the second bevel pulley 192 to rotate counterclockwise.

For reference, although not illustrated in this drawing, a driving pulley connected to a driving motor to rotate the first bevel pulley 191 may be provided separately, and the driving pulley may be connected to the first bevel pulley 191 by a cable 193 so that the first bevel pulley 191 rotates according to the rotation of the driving pulley.

The power transmission shaft 194 is coupled to the second bevel pulley 192 to rotate together with the second bevel pulley 192, and is coupled to the rotational axis unit 130 to transmit rotational force to the rotational axis unit 130. The power transmission shaft 194 may be coupled to the second joint 133 that is rotatably installed in the hollow portion of the first frame unit 110.

In this way, by disposing the first bevel pulley 191 and the second bevel pulley 192 to be perpendicular to each other and connecting the first bevel pulley 191 and the second bevel pulley 192 using the cable 193, the rotational force is transmitted to the rotational axis unit 130 connected to the second bevel pulley 192, so the yaw rotation of the joint device 100 may be implemented.

Meanwhile, the sensing unit 103 may be provided to sense the rotation angle when the rotational axis unit 130 is rotated in place (e.g., is yaw rotated). For example, the sensing unit 103 may sense the rotation angle of the rotational axis unit 130 by detecting the rotation of the second bevel pulley 192. In this drawing, it is illustrated that the sensing unit 103 is installed on the substrate 102, which is disposed to overlap the second bevel pulley 192, to detect the rotation of the second bevel pulley 192.

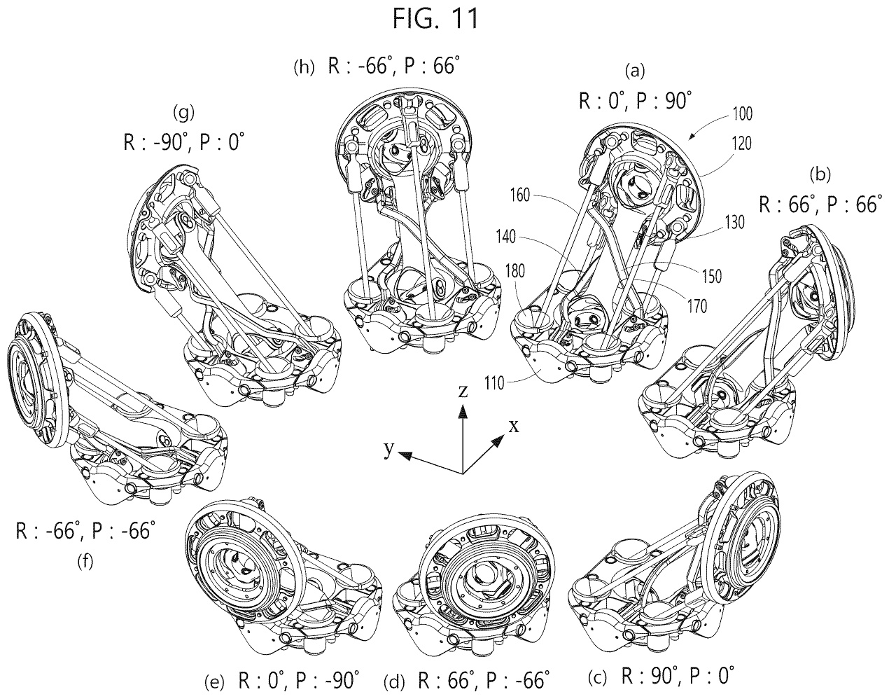

FIG. 11 is a conceptual diagram illustrating the structural change of part A when the second frame unit illustrated in FIG. 2 performs the rolling motion (roll and/or pitch rotation) on the virtual sphere.

Referring to FIG. 11 together with FIGS. 1 to 3, 8 and 9 above, the second frame unit 120 may perform the rolling motion on the virtual sphere with respect to the first frame unit 110 and may be roll and/or pitch rotated by adjusting the lengths of both sides of the first and second cable units 160 and 170.

Meanwhile, when the rotational axis unit 130 described above is rotated in place (e.g., is yaw rotated), in addition to the sensing unit 103 for sensing the rotation angle, a sensing unit 104 for sensing the roll and/or pitch rotation angle may be additionally provided. As described above, the first and second cams 141 and 151 rotate with respect to the first and second axes during the roll and/or pitch rotation. Using this, the sensing unit 104 may be installed on the first frame unit 110 and the first and second cams 141 and 151 to sense the rotation angles of the first and second link units 140 and 150 around the first and second axes.

In this way, because the sensing units 103 and 104 are configured to sense the rotation angles of the first and second link units 140 and 150 around the first and second axes and the rotational axis unit 130 around the third axis, the rotation angle of the joint may be accurately measured. When the joint device 100 of the present inventive concepts is provided at the wrist joint portion of the robot, the sensing technology may be applied to control the driving of the wrist more precisely.

Hereinafter, the structure that can solve problems such as sudden bending of the cable, damage caused by the bending, and/or errors will be described.

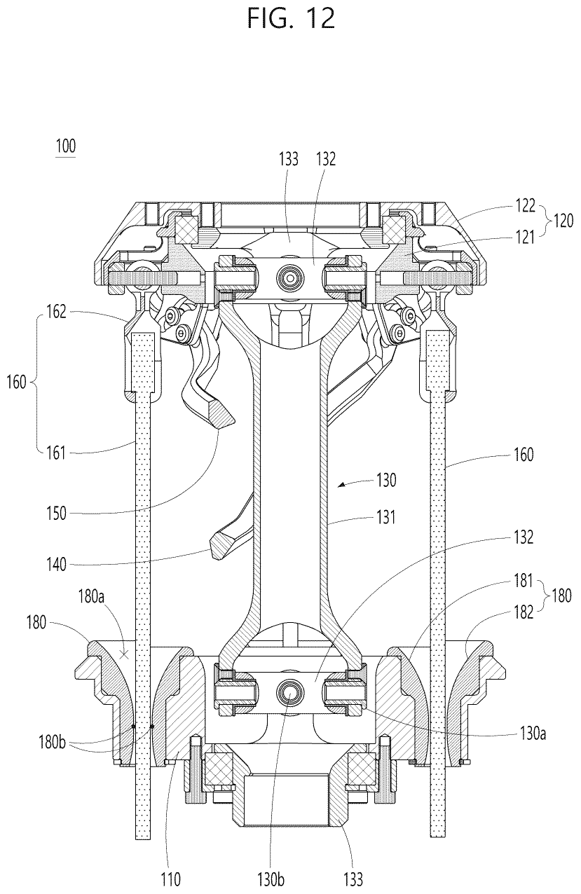

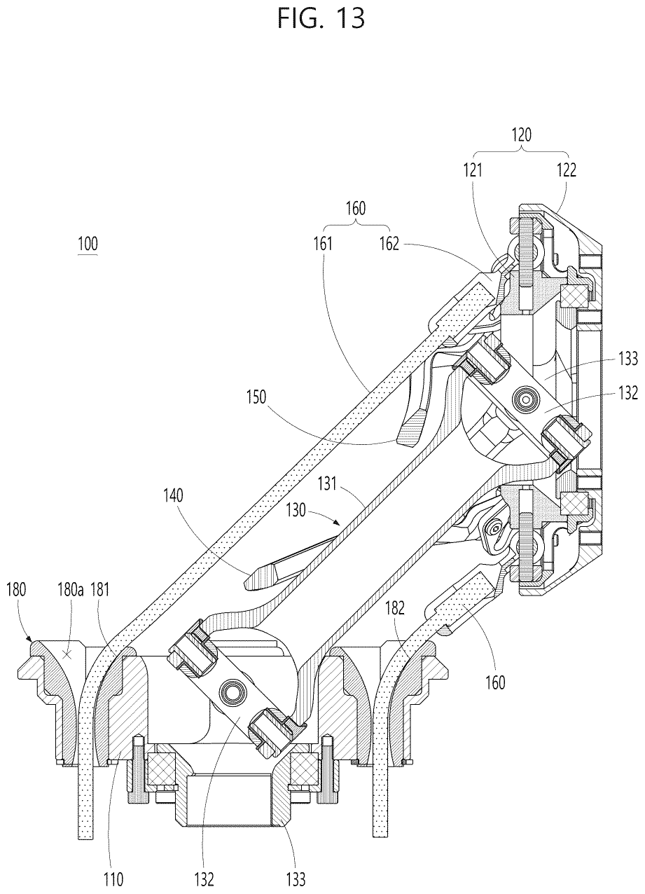

FIG. 12 is a cross-sectional view of part A of FIG. 1, and FIG. 13 is a conceptual diagram illustrating the state in which the second frame unit 120 performs the rolling motion (roll and pitch rotation) on the virtual sphere in the state illustrated in FIG. 12.

Referring to FIGS. 12 and 13 together with FIGS. 1 to 3 above, the first frame unit 110 is provided with a cable guide 180 that guides the bending of the first and second cable units 160 and 170. The cable guide 180 is installed in the hole 110b of the first frame unit 110 and has an opening 180a through which the first or second cable unit 160 and 170 pass.

The cable guide 180 is provided at four locations of the first frame unit 110. A pair of cable guides 180 through which both sides of the first cable unit 160 pass are provided on both sides of the rotational axis unit 130, respectively, and another pair of cable guides 180 through which both sides of the second cable unit 170 pass are provided in a direction perpendicular to the pair of cable guides 180.

An inner side surface of the opening 180a of the cable guide 180 is provided with rounded portions 181 and 182 that are formed to protrude inwardly of the opening 180a. The rounded portions 181 and 182 are formed to guide the bending of the first and second cable units 160 and 170 when the second frame unit 120 performs the rolling motion (roll and/or pitch rotation) on the virtual sphere.

A point 180b of the rounded portions 181 and 182 protruding maximally inwardly of the opening 180a is located further away from the second frame unit 120 than first and second rotational axes corresponding to the first and second axes. Referring to FIG. 12, the maximally protruding point 180b is positioned below a connecting axis 130a of the shaft 131 and the first joint 132, and a connecting axis 130b of the first joint 132 and the second joint 133.

Meanwhile, as illustrated in FIG. 13, when the second frame unit 120 performs the rolling motion (roll and pitch rotation) on the virtual sphere, one side of each cable unit is in contact with the inner round 181 adjacent to the rotational axis unit 130, and the other side of each cable unit is in contact with the outer round 182, and there is a difference in their contact ranges.

Considering this, the outer round portion 182 may extend upward more than the inner round portion 181. That is, the outer round 182 may be higher, thereby compensating for the above-described difference in contact ranges.

In this way, the first frame unit 110 is provided with the cable guide 180, so the bending of the cable may be smoothly guided, and the cable guide 180 has a design that is divided into the inner round 181 and the outer round 182 in consideration of the difference in the contact range of the cable, so the cable errors due to the bending may be reduced or minimized.

Hereinafter, a wiring structure utilizing the empty space of the rotational axis unit 130 will be described.

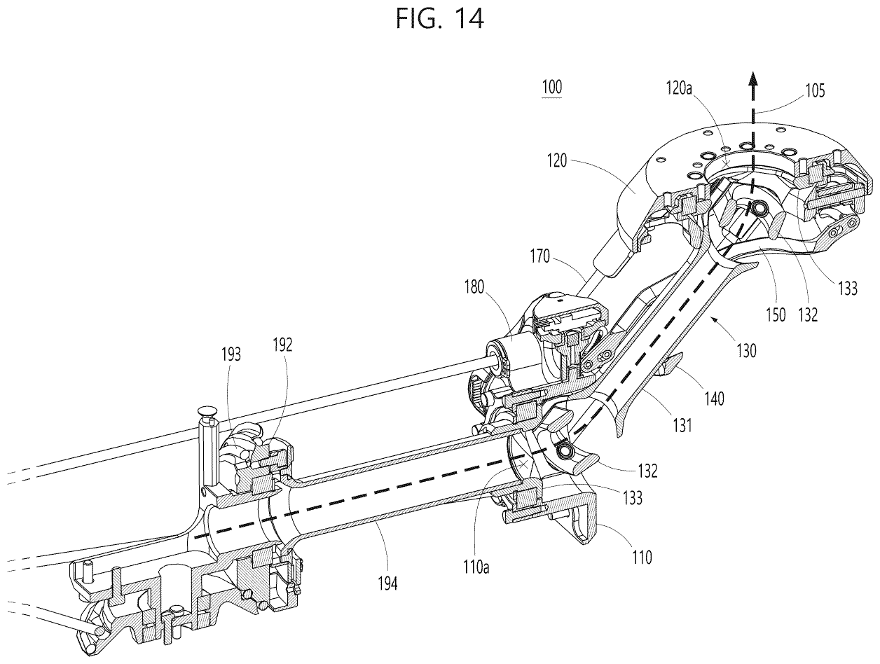

FIG. 14 is a cross-sectional diagram of the robot joint device 100 illustrated in FIG. 1.

Referring to FIG. 14, an electric cable 105 is disposed to pass through the rotational axis unit 130. To this end, the shaft 131 has a hollow shape with both ends open, and the first and second joints 132 and 133 each have a hollow portion. In addition, the power transmission shaft 194, which is connected to the rotational axis unit 130 to transmit power, also has a hollow shape.

Accordingly, the electric cable 105 may be disposed to pass through the inside of the power transmission shaft 194 and the inside of the rotational axis unit 130. For reference, the electric cable 105 may be connected to the hand 101 to apply power or a signal to the hand 101.

In this way, the electric cable 105 may be disposed to pass through the inside of the shaft 131 and the first and second joints 132 and 133, thereby reducing or preventing problems such as the twisting and tension of the electric cable 105 that may be caused by the driving of the joint in the structure in which the existing electric cable 105 is disposed externally.

Meanwhile, the above-described detailed description is to be interpreted as being illustrative rather than being restrictive in all aspects. The scope of the present inventive concepts is to be determined by reasonable interpretation of the claims, and all modifications within an equivalent range of the present inventive concepts fall in the scope of the present inventive concepts.

What is claimed is:

1. A robot joint device, comprising:
a first frame unit having a first hollow portion;
a second frame unit spaced apart from the first frame unit and having a second hollow portion;
a rotational axis unit installed on and between the first hollow portion and the second hollow portion and configured to be rotatable around a first axis, a second axis, and a third axis, the first, second and third axes being perpendicular to one another;
a first link unit extending to bypass the rotational axis unit, connected to each of the first and second frame units with the rotational axis unit interposed therebetween, and configured to be rotatable around the first and second axes; and
a second link unit extending to bypass the rotational axis unit while intersecting with the first link unit, connected to each of the first and second frame units with the rotational axis unit interposed therebetween, and configured to be rotatable around the first and second axes,
wherein each of the first and second link units has a cam slider portion configured to correct a connection length with the first and second frame units when rotating for a rolling motion, so that the second frame unit performs the rolling motion on a virtual sphere with respect to the first frame unit.

2. The robot joint device of claim 1, wherein
one end part of the first link unit connected to the first frame unit and one end part of the second link unit connected to the first frame unit are perpendicular to each other with respect to the rotational axis unit, and
the other end part of the first link unit connected to the second frame unit and the other end part of the second link unit connected to the second frame unit are perpendicular to each other with respect to the rotational axis unit.

3. The robot joint device of claim 1, wherein the cam slider portion is at at least one of both pend parts of the first link unit and both end parts of the second link unit, respectively.

4. The robot joint device of claim 3, wherein
the first link unit includes
a first cam installed on the first and second frame units and configured to be rotatable around the first axis, and
a first link installed on the first cam and configured to be rotatable around the second axis and configured to be relatively movable with respect to the first cam by slide movement, and
the second link unit includes
a second cam installed on the first and second frame units and configured to be rotatable around the second axis, and
a second link d on the second cam and configured to be rotatable around the first axis and configured to be relatively movable with respect to the second cam by the slide movement.

5. The robot joint device of claim 4, wherein
each of the first and second cams includes a pinhole and a cam slot defined therein;
each of the first and second links includes a hole and a slot defined therein;
a link slider mounted in the pinhole and configured to be movable along the slot; and
a cam slider mounted in the hole and configured to be movable along the cam slot.

6. The robot joint device of claim 4, further comprising:
a sensing unit installed on the first frame unit and the first and second cams and configured to sense rotation angles of the first and second link units with respect to the first and second axes.

7. The robot joint device of claim 1, further comprising:
a driving unit configured to rotate the second frame unit around the first and second axes with respect to the first frame unit.

8. The robot joint device of claim 7, wherein the driving unit includes:
a first cable unit wound around a first pulley so that both sides of the first cable unit pass through the first frame unit and both end parts of the first cable unit are rotatably installed on the second frame unit; and
a second cable unit wound around a second pulley so that both sides of the second cable unit pass through the first frame unit and both end parts of the second cable unit are rotatably installed on the second frame unit, and
between the first frame unit and the second frame unit, both sides of the first cable unit are positioned on a first plane, and both sides of the second cable unit are positioned on a second plane perpendicular to the first plane.

9. The robot joint device of claim 8, further comprising:
a cable guide installed in a hole of the first frame unit and having an opening through which the first or second cable unit passes,
wherein an inner side surface of the opening is provided with a rounded portion protruding inwardly, and
the rounded portion is configured to guide bending of the first and second cable units when the second frame unit rotates with respect to the first frame unit.

10. The robot joint device of claim 9, wherein the rounded portion includes:
an inner round adjacent to the rotational axis unit; and
an outer round extending upwardly than the inner round.

11. The robot joint device of claim 9, wherein a point of the rounded portion protruding maximally inwardly of the opening is further away from the second frame unit than first and second rotational axes of the rotational axis unit corresponding to the first and second axes.

12. The robot joint device of claim 1, wherein the rotational axis unit includes:
a shaft having a hollow structure;
a first joint having a hollow portion and being installed at both end parts of the shaft and configured to be rotatable around the first axis; and
a second joint having a hollow portion, connected to the first joint to be rotatable around the second axis, and installed at the first and second hollow portions to be rotatable around the third axis.

13. The robot joint device of claim 12, further comprising:
a power transmission unit configured to transmit power to the rotational axis unit,
wherein the power transmission unit includes
a first bevel pulley,
a second bevel pulley being perpendicular to the first bevel pulley,
a cable wound around the first bevel pulley and the second bevel pulley to rotate the second bevel pulley by winding, and
a power transmission shaft coupled to the second bevel pulley and configured to transmit rotational force to the rotational axis unit.

14. A robot joint device, comprising:
a first frame unit having a first hollow portion;
a second frame unit spaced apart from the first frame unit and having a second hollow portion;
a rotational axis unit installed on and between the first hollow portion and the second hollow portion and configured to be rotatable around a first axis, a second axis, and a third axis, the first, second, and third axes being perpendicular to one another;
a first link unit extending to bypass the rotational axis unit, connected to each of the first and second frame units with the rotational axis unit interposed therebetween, and configured to be rotatable around the first and second axes;
a second link unit extending to bypass the rotational axis unit while intersecting with the first link unit, connected to each of the first and second frame units with the rotational axis unit interposed therebetween, and configured to be rotatable around the first and second axes;
a first cable unit wound around a first pulley so that both sides of the first cable unit pass through the first frame unit and both end parts of the first cable unit are rotatably installed on the second frame unit; and
a second cable unit wound around a second pulley so that both sides of the second cable unit pass through the first frame unit and both end parts of the second cable unit are rotatably installed on the second frame unit,
wherein, between the first frame unit and the second frame unit, both sides of the first cable unit are on a first plane, and both sides of the second cable unit are on a second plane perpendicular to the first plane.

15. The robot joint device of claim 14, further comprising:
a cable guide installed in a hole of the first frame unit and having an opening through which first or second cable unit passes,
wherein an inner side surface of the opening is provided with a rounded portion protruding inwardly to guide bending of the first and second cable units when the second frame unit rotates with respect to the first frame unit.
